(19) United States
(12) Patent Application Publication
(10) Pub. No.: US 2010/0302134 A1
(43) Pub. Date: Dec. 2, 2010

(54) LIQUID CRYSTAL DISPLAY DEVICE

(75) Inventor: Atsushi HASEGAWA, Togane (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/789,482

(22) Filed: May 28, 2010

(30) Foreign Application Priority Data
May 29, 2009 (JP) 2009-129920

(51) Int. Cl. G09G 3/36

(52) U.S. Cl. 345/102

(57) ABSTRACT

The liquid crystal display panel of the present invention is formed of a number of pixels that are arranged in a matrix in a display region and a number of light sensor circuits that are provided in the display region, each of the number of light sensor circuits has a light sensor element, the backlight has a first light intensity and a second light intensity that is different from the first light intensity, the first light intensity and the second light intensity are switched between periodically with a predetermined period, the light sensor circuits have a light receiving period during which the amount of light is detected and a readout period during which the amount of light detected during the light receiving period is read out, the light receiving period is an integer multiple of the predetermined period, the light sensor elements have a light sensor operating state with a sensitivity to light and a light sensor non-operating state without sensitivity to light during the light receiving period, and the light sensor operating state and the light sensor non-operating state are switched between periodically with the predetermined period in sync with the switching of the light intensity of the backlight.

### CROSS-REFERENCE TO RELATED APPLICATION

The present application claims priority over Japanese Application JP 2009-129920 filed on May 29, 2009, the contents of which are hereby incorporated into this application by reference.

### BACKGROUND OF THE INVENTION

(1) Field of the Invention

The present invention relates to a liquid crystal display device, and in particular, to a liquid crystal display device having a backlight where at least some of a number of pixels have a light sensor element.

(2) Description of the Related Art

Common liquid crystal display devices are formed of a liquid crystal display panel and a backlight that works as a surface light source on the rear of the liquid crystal display panel. This is because a number of pixels formed in the display region of the liquid crystal display panel do not emit light by themselves and only function to change the light transmittance by driving the molecules of the liquid crystal.

In addition, liquid crystal display panels have been known in recent years where all the pixels have a light sensor element in them so that the light sensor elements arranged in a matrix within the display region function as a touch panel so that the liquid crystal display panel can replace conventional touch panels. That is to say, when a light blocking body, such as a finger, makes contact with (or approaches) the display region of the liquid crystal display panel, light sensor elements detect this and calculate the X and Y coordinate for the location of the above described light blocking body so that this information is reflected in the display device.

Such a technology is disclosed in JP 2006-3857A and JP 2007-94606A, for example.

### SUMMARY OF THE INVENTION

In the above described liquid crystal display device, however, there may be an disadvantage such that light sensor elements cannot detect a light blocking body, such as a finger, depending on the relationship in the intensity between external light and light from the backlight.

FIGS. 10 to 12 are diagrams for illustrating the causes of the above described disadvantage. FIGS. 10 and 11 respectively show a case where there is no disadvantage, and FIG. 12 shows a case where there is a disadvantage. Here, FIGS. 10 to 12 respectively show a liquid crystal display panel PNL provided with a pair of substrates SUB1 and SUB2 that are positioned so as to face each other and sandwich liquid crystal LC, where a backlight BL is provided on the substrate SUB1 side. In addition, a number of light sensor elements LS (denoted as LS1, LS2, LS3 and LS4 in the figures) are formed on the surface of the substrate SUB1 on the liquid crystal LC side. Each of these light sensor elements LS is provided in a pixel of the liquid crystal display panel PNL (the structure of the pixel is not shown in the figures). In addition, though not shown, the light sensor elements LS have such a structure that light from the below described backlight B is blocked (see symbol LI in FIG. 5). Furthermore, a light blocking body ITL, such as a finger, makes contact with or is in proximity to the surface of the liquid crystal display panel PNL on the substrate SUB2 side.

First, as shown in FIG. 10, in the case where external light A is sufficiently bright in comparison with the light from the backlight B, there is a large difference in the brightness of the detected light between the light sensor elements LS1 and LS2 which detect external light A without the light being blocked by the light blocking body ITL and the light sensor elements LS3 and LS4 which detect light from the backlight B reflected from the light blocking body ITL, and thus, the light sensor elements LS can detect the light blocking body ITL with high reliability.

In addition, as shown in FIG. 11, in the case where the light from the backlight B is sufficiently bright in comparison with external light A as well, there is a large difference in the brightness of the detected light between the light sensor elements LS1 and LS2 which detect external light A without the light being blocked by the light blocking body ITL and the light sensor elements LS3 and LS4 which detect the light from the backlight B reflected from the light blocking body ITL, and thus, the light sensor elements LS can detect the light blocking body ITL with high reliability.

As shown in FIG. 12, however, in the case where external light A and light from the backlight B have approximately the same level of brightness, there is a small difference in the brightness of the detected light between the light sensor elements LS1 and LS2 which detect external light A without the light being blocked by the light blocking body ITL and the light sensor elements LS3 and LS4 which detect the light from the backlight B reflected from the light blocking body ITL, and thus, the light sensor elements LS cannot detect the light blocking body ITL with high reliability.

The case in FIG. 12 is described in further detail below. FIG. 13 is a diagram showing a part of FIG. 12 including the light sensor elements LS2 and LS3. In FIG. 13, light from the backlight B attenuates when passing through (2) in the cross sectional diagram, attenuates when reflected from the light blocking body ITL in (3) in the figure, and attenuates when passing through (4) in the cross sectional diagram before reaching the light sensor element LS3. Here, in order to make it easy to understand, numerical values are substituted for the below described elements.

That is to say, the amount of light from the backlight BL=1000 (arbitrary unit), the attenuation in the path (2) in the figure=93% (the transmittance of the liquid crystal display panel PNL is assumed to be 7%), the attenuation in the path (3) in the figure=80% (the reflectance of the light blocking body ITL is assumed to be 20%), and the attenuation in (4) in the figure=50%.

In this case, the amount of light Z that enters into the light sensor element LS3 can be calculated in the following formula (1).

Z=1000×(1−0.93)×(1−0.8)×(1−0.5)=7 (1)

Meanwhile, when the reduction of external light A when passing through (5) in the cross sectional diagram before reaching the light sensor element LS2 is 50% as in (4) in the figure and the amount of external light A is 14, the amount of light Z′ that enters into the light sensor element LS2 can be calculated in the following formula (2).

Z′=14×(1−0.5)=7=Z (2)

Therefore, Z′=Z and the light sensor elements LS cannot distinguish external light A from light from the backlight B, and thus, the light blocking body ITL cannot be detected with high reliability.

An object of the present invention is to provide a liquid crystal display device where a light blocking body can be detected without fail irrelevant of the degree of brightness of external light and light from the backlight.

The following are the examples of the configuration of the present invention.

(1) The present invention provides a liquid crystal display device having a liquid crystal display panel and a backlight that is positioned so as to face the above described liquid crystal display panel, characterized in that

the above described liquid crystal display panel is formed of a number of pixels that are arranged in a matrix in a display region and a number of light sensor circuits that are provided in the above described display region,

each of the above described number of light sensor circuits has a light sensor element,

the above described backlight has a first light intensity and a second light intensity that is different from the above described first light intensity, and

the above described first light intensity and the above described second light intensity are switched between periodically with a predetermined period.

(2) The present invention also provides the liquid crystal display device according to (1), characterized in that

the above described light sensor circuits have a light receiving period during which the amount of light is detected and a readout period during which the amount of light detected during the above described light receiving period is read out,

the above described light receiving period is an integer multiple of the above described predetermined period,

the above described light sensor elements have a light sensor operating state with a sensitivity to light and a light sensor non-operating state without sensitivity to light during the above described light receiving period, and

the above described light sensor operating state and the above described light sensor non-operating state are switched between periodically with the above described predetermined period in sync with the switching of the light intensity of the above described backlight.

(3) The present invention also provides the liquid crystal display device according to (2), characterized in that the above described readout period is the above described predetermined period.

(4) The present invention also provides the liquid crystal display device according to (2) or (3), characterized in that

the above described number of light sensor circuits are arranged in a matrix,

a number of light sensor circuits aligned in the same column from among the above described number of light sensor circuits take the above described readout period in sequence, and

the light intensity of the above described backlight when light sensor elements are in the above described light sensor operating state is different between light sensor circuits in odd rows and light sensor circuits in even rows from among the number of light sensor circuits aligned in the same column.

(5) The present invention also provides the liquid crystal display device according to any of (1) to (4), characterized in that the above described predetermined period is one horizontal scanning period.

(6) The present invention also provides the liquid crystal display device according to any of (1) to (4), characterized in that the above described predetermined period is an integer multiple of one horizontal scanning period.

(7) The present invention also provides the liquid crystal display device according to any of (1) to (6), characterized in that the above described first light intensity is a state in which the light source of the above described backlight is turned on and the above described second light intensity is a state in which the above described light source is turned off.

(8) The present invention also provides the liquid crystal display device according to any of (1) to (7), characterized in that the above described light sensor circuits have a light sensor element, a capacitor element and a switch, and the above described light sensor element and the above described capacitor element are connected in series with the above described switch in between.

(9) The present invention also provides the liquid crystal display device according to (8), characterized in that the above described switches are formed of a thin film transistor.

(10) The present invention also provides the liquid crystal display device according to any of (1) to (9), characterized in that the above described light sensor circuits are each formed in one of the above described number of pixels.

(11) The present invention also provides the liquid crystal display device according to any of (1) to (9), characterized in that the above described light sensor circuits are provided in part of the above described display region.

Here, the above described structures are merely examples, and the present invention allows for appropriate modifications, as long as the technical idea is not deviated from. In addition, examples of the structure of the present invention other than those described above will become clearer throughout the description of the present specification and the drawings.

The above described liquid crystal display device allows light blocking bodies to be detected without fail, irrespectively of the level of brightness of external light or light from the backlight.

Other effects of the present invention will become clearer throughout the description of the specification.

### BREIF DESCRIPTION OF THE DRAWINGS

FIG. 1 is a diagram showing modulation of the backlight in the liquid crystal display device according to the present invention and the timing for the non-operation of the light sensor elements accompanying the modulation;

FIG. 2 is a schematic plan diagram showing the liquid crystal display device according to the present invention;

FIG. 3 is a diagram showing the light sensor circuit provided in the liquid crystal display device according to the present invention;

FIG. 4 is a diagram showing the operation of the light sensor circuit provided in the liquid crystal display device according to the present invention;

FIG. 5 is a cross sectional diagram showing the structure of a transistor for selecting a pixel and a light sensor element provided in the liquid crystal display device according to the present invention;

FIG. 6 is a schematic plan diagram showing light sensor elements arranged in a matrix in the display region of the liquid crystal display device according to the present invention;

FIG. 7 is a diagram showing the timing for receiving light in light sensor elements and the output readout in the liquid crystal display device according to the present invention;

FIG. 8 is a conceptual circuit diagram showing a light sensor circuit where the sensitivity of a light sensor element is nullified in the liquid crystal display device according to an embodiment of the present invention;

FIG. 9 is a concrete circuit diagram showing a light sensor circuit where the sensitivity of a light sensor element is nullified in the liquid crystal display device according to an embodiment of the present invention;

FIG. 10 is a diagram showing the state of a conventional liquid crystal display device where there is no disadvantage due to a certain state of external light;

FIG. 11 is a diagram showing the state of a conventional liquid crystal display device where there is no disadvantage due to another state of external light;

FIG. 12 is a diagram showing the state of a conventional liquid crystal display device where there is a disadvantage due to a state of external light; and

FIG. 13 is a diagram for illustrating the disadvantage of the conventional liquid crystal display device in further detail.

### DESCRIPTION OF THE PREFERRED EMBODIMENTS

The preferred embodiments of the present invention are described below in reference to the drawings. Here, the same symbols are used for components that are the same or similar in the drawings and embodiments, and the descriptions thereof are not repeated.

### First Embodiment

### Schematic Structure of Entirety

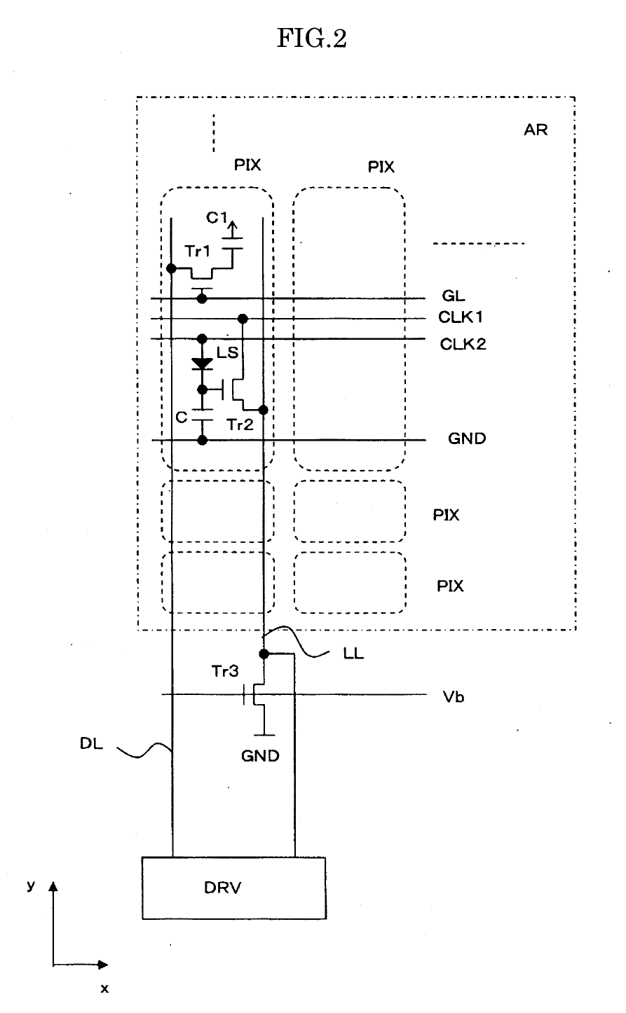

FIG. 2 is a plan diagram schematically showing a liquid crystal display device where a light sensor is provided in each pixel.

A number of pixels PIX that are arranged in a matrix are formed on the main surface of a liquid crystal display panel. This set of pixels PIX forms a display region AR. Each pixel PIX has a region that functions as a liquid crystal display and a region that functions to detect light. The region that functions as a liquid crystal display is provided with a thin film transistor Tr1 that is turned on by a signal (scan signal) from a gate signal line GL, a pixel electrode (not shown) to which a signal is supplied from a drain signal line DL through the thin film transistor Tr1 when turned on, and a storage capacitance C1 for storing a video signal supplied to the pixel electrode long-term. In addition, in the region that functions to detect light, a light sensor element LS and a capacitor element C are formed so as to be connected in series between a second control signal line CLK2 and a grounding line GND. In the present embodiment, the light sensor elements LS are formed of photodiodes. The capacitor elements C convert the current detected by the light sensor elements LS to a voltage. In addition, a thin film transistor Tr2 of which the gate electrode is connected to the contact point between the light sensor element LS and the capacitor element C is provided so that the thin film transistor Tr2 is connected between a first control signal line CLK1 and a signal line LL. A thin film transistor Tr3 that is connected between the above described signal line LL and a grounding line GND is formed outside the display region AR. Here, the thin film transistor Tr2 forms a readout circuit together with the thin film transistor Tr3. The output of a sensor circuit is outputted to an external circuit DRV from the connection point between the thin film transistor Tr2 and the thin film transistor Tr3 in the above described readout circuit. This external circuit DRV also functions to supply a video signal to the above described drain signal line DL, for example. The first control signal line CLK1, the second control signal line CLK2 and the grounding line GND run in the direction x in the figure and are shared by pixels PIX aligned in the direction x. The signal line LL runs in the direction y in the figure and is shared by pixels PIX aligned in the direction y. Here, a predetermined bias voltage Vv for turning on the thin film transistor Tr3 is applied to the gate electrode of the thin film transistor Tr3.

The thus formed light sensor circuit does not use the gate signal lines GL for driving pixels PIX or the drain signal lines DL, and therefore can function independently from the liquid crystal display. However, the sensor circuit may share the gate signal line GL and the drain signal line DL so as to provide a structure that works in sync with the liquid crystal display.

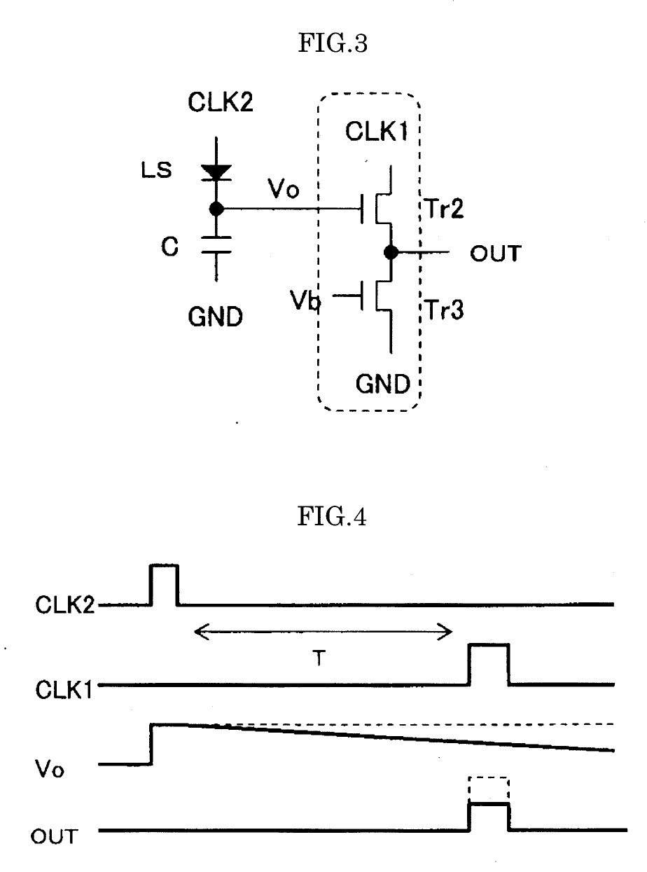

Here, the operation of sensor circuits having the above described light sensor elements LS is described. FIG. 3 shows the light sensor element LS, the capacitor element C, the thin film transistor Tr2 and the thin film transistor Tr3 shown in the circuit in FIG. 2. The part of the figure inside the dotted box, which includes the thin film transistor Tr2 and the thin film transistor Tr3, forms a source follower which converts change in the potential in response to light in the light sensor element LS to an impedance which is then outputted. Here, FIG. 4 is a timing chart for the above described sensor circuit. The timing in each part is shown so as to correspond to the symbols (CLK1, Vo and the like) in FIG. 3. In FIGS. 3 and 4, the capacitor element C is charged by making the second control signal line CLK2 high, and the sensor circuit starts operating (detection of received light) at the point in time when the second control signal line CLK becomes low. When the light sensor element LS receives light, the charge in the capacitor element C is released to the second control signal line CLK2, so that the potential of the capacitor element C lowers. This decrease in the potential is integrated by the operation time of the sensor circuit, so that the potential of the capacitor element C becomes of a value corresponding to the amount of light received during the operation time. Thus, the source follower made up of the thin film transistor Tr2 and the thin film transistor Tr3 starts operating when the first control signal line CLK1 becomes high, and the potential Vo at this time becomes the output of the sensor OUT via the source follower. As a result, the time between the point when the second control signal line CLK2 becomes low and the point when the first control signal line CLK1 becomes high is the time during which the sensor receives light T. The dotted lines in Vo and OUT in FIG. 4 are the output when there is no irradiation with light (dark state), and the difference from the full line corresponds to the amount of received light.

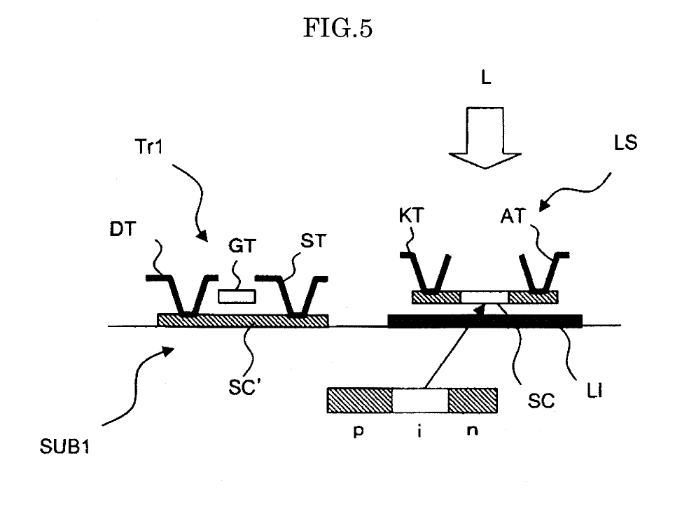

Here, FIG. 5 is a schematic cross sectional diagram showing the structure of the light sensor elements LS and comparing it to that of the thin film transistors Tr1. The thin film transistor Tr1 is an MIS (metal insulator semiconductor) transistor having a top gate structure, for example, and amorphous Si or poly Si is used for the semiconductor layer SC′. The symbol GT in the figure is a gate electrode, DT is a drain electrode, and SST is a source electrode. The thin film transistors Tr2 and Tr3 in FIG. 2 have the same structure. The light sensor element LS is formed as a diode, usually together with the thin film transistor Tr1. Thus, the semiconductor layer SC is made of the same material as the semiconductor layer SC′ in the thin film transistor Tr1. The symbol KT in the figure is a cathode electrode, and AT is an anode electrode. In addition, an i type layer is formed at the center of the semiconductor layer SC, and the region connected to the cathode electrode KT is a p type layer and the region connected to the anode electrode AT an n type layer. Here, the light sensor element LS is provided so as to receive only light L coming from the top in the figure, and a light blocking film LI is formed between the substrate SUB1 and the light sensor element LS in order to block light from the backlight, not shown.

(Timing with which Light is Received by Light Sensor Elements LS and Data Readout)

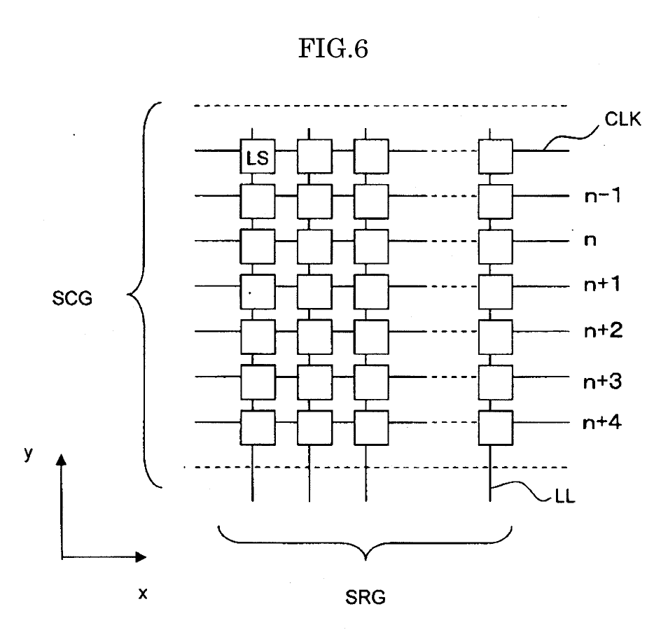

FIG. 6 shows the state of alignment of light sensors OS in the display region AR of the liquid crystal display panel PNL. The light sensors LS are formed in respective pixels for the liquid crystal display, as described above and thus formed in a matrix on the surface of the display region AR, just as the pixels.

A common control signal line CLK (control signal lines CLK1 and CLK2 in FIG. 2) is formed for each pixel group made up of pixels aligned in the direction x in the figure, and these control signal lines CLK form a sensor control line group SCG. A common signal line LL (signal line LL in FIG. 2) is formed for each pixel group made up of pixels aligned in the direction y in the figure, and these signal lines LL form a sensor readout line group SRG. Pixels controlled by one control signal line CLK (pixels aligned in the direction x in the figure) start receiving light, and this data is read out through the signal lines LL. As for the timing with which light is received by the light sensor elements LS and data is read out, the order is n−1, n, n+1, n+2, n+3, n+4 and so on in pixel groups of pixels aligned in the direction x in the figure, as with video signals that are written into pixels for liquid crystal displays.

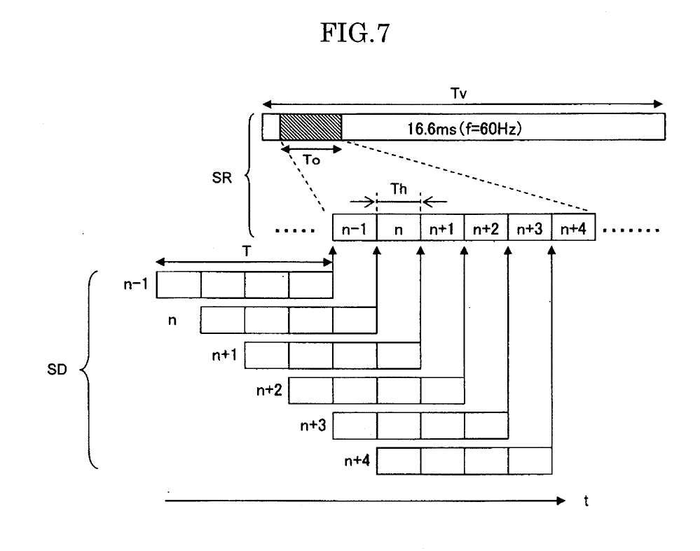

FIG. 7 schematically shows the timing with which light is received (detected) by light sensor elements and data is read out. The top in FIG. 7 shows the timing of the sensor readout period SR and the bottom shows the timing of the sensor light receiving period SD. First, in the case where the panel has a frame frequency f of 60 Hz, one vertical period Tv becomes approximately 16.6 ms, including a so-called retrace line period. Taking only the six rows n−1, n, n+1, n+2, n+3 and n+4 as an example from among the rows of pixel groups in FIG. 6, the sensor readout period SR in the light sensor elements LS is part of one vertical period Tv (indicated by To in the figure). In this case, the sensor readout period SR in the light sensor elements LS is allocated within one horizontal scan period Th for each of the rows from n−1 to n+4. That is to say, the light sensor elements LS in each row are read out within one horizontal scan period Th, as with the pixels driven in the row. Here, data that is read out from the light sensor elements LS (output) is data on the amount of light received by the light sensor elements LS before it is read out. In the light sensor elements LS in FIG. 7, the sensor light receiving time T (corresponding to the symbol T in FIG. 4) starts at a point four horizontal scan periods before each actual row, and the data that is read out by the light sensor elements LS in each row has a value corresponding to the integral value of the amount of light received within the four horizontal scan periods. Though in this embodiment, four horizontal scan periods are used for the sensor light receiving time, the invention is not limited to this. The period may be changed to any in accordance with the sensitivity of the light sensor elements LS, the amount of light from the backlight and the amount of external light.

(Modulation of Backlight and Accompanying Non-Operation of Light Sensor Elements)

In the present embodiment, the brightness of light from the backlight is modulated with a predetermined period, and furthermore, the light sensors are operated so as to be switched between the sensitive state and the insensitive state so as to be able to detect the light blocking body without fail, irrespectively of the level of the brightness of external light and light from the backlight.

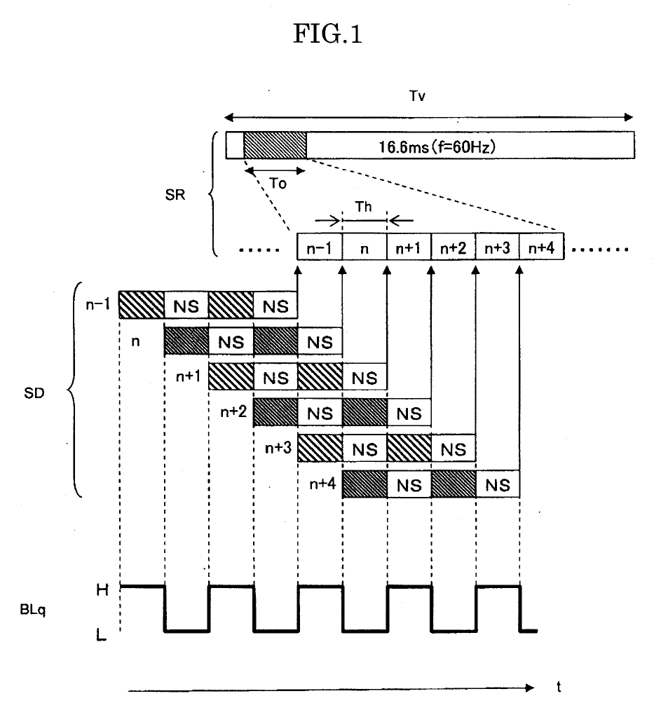

FIG. 1 schematically shows the above described operation. FIG. 1 also shows the same diagram as in FIG. 7 in order to clarify the timing for modulation of the brightness of the backlight. Thus, the top in FIG. 1 shows the timing for the sensor readout period SR, the middle shows the timing for the sensor light receiving period SD, and the bottom shows the amount of light from the backlight BLq.

As shown in FIG. 1, the amount of light from the backlight BLq is modulated so that a state with a large amount of light (H; first intensity) and a state with a small amount of light (L; second intensity) alternate for each horizontal scan period Th. In this case, the average brightness of the backlight is set to a value between H and L.

In addition, a sensitive state (state in which the light sensor operates, shown by hatched boxes) and an insensitive state (state in which the light sensor does not operate, indicated by the symbol NS in the figure) are created for each horizontal scan period during the sensor light receiving period SD of the light sensor elements LS in each row. As a result, the light sensor elements LS in the row n−1 become of the sensitive state four horizontal scan periods before the actual row, where the amount of light from the backlight BLq is H and two horizontal scan periods before the actual row, and of the insensitive state three horizontal scan periods before the actual row, where the amount of light from the backlight BLq is L and one horizontal scan period before the actual row. In addition, the light sensor elements LS in the row n become of the sensitive state four horizontal scan periods before the actual row, where the amount of light from the backlight BLq is L and two horizontal scan periods before the actual row, and of the insensitive state three horizontal scan periods before the actual row, where the amount of light from the backlight BLq is H and one horizontal scan period before the actual row.

As is clear from the above, the output of the light sensor elements LS in the row n−1 is only the data when the amount of light from the backlight BLq is H, while the output of the light sensor elements LS in the row n is only the data when the amount of light from the backlight BLq is L. This means that the light sensor elements LS in odd rows and the light sensor elements LS in even rows throughout the panel output data on received light when the amount of light from the backlight is different.

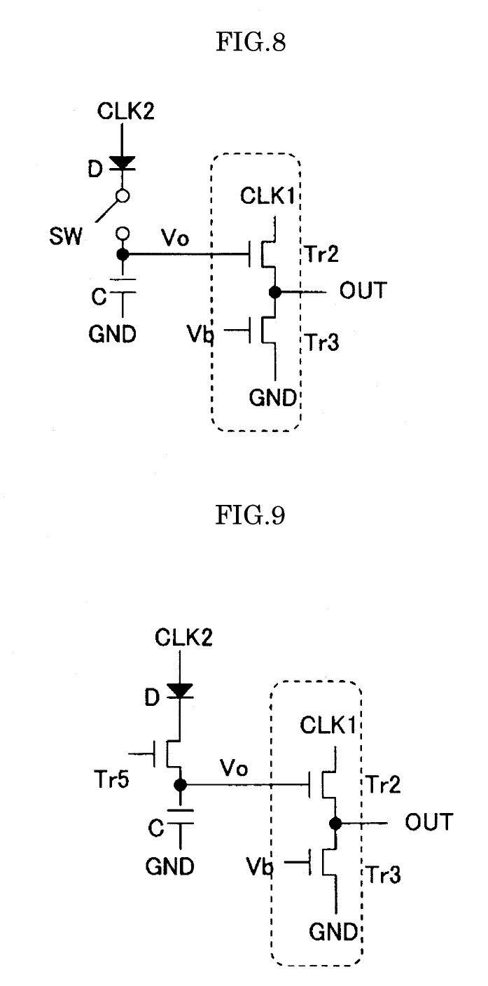

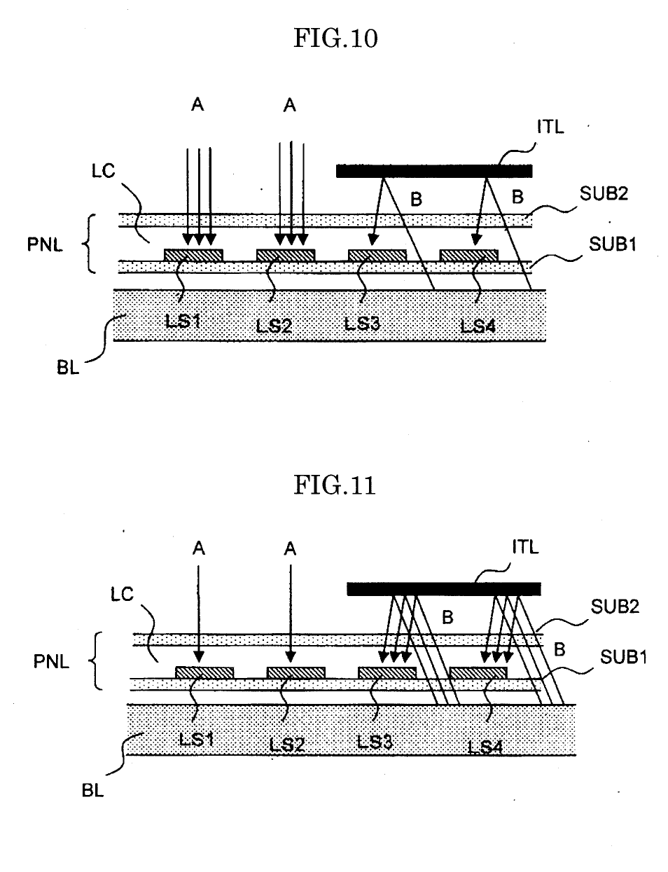

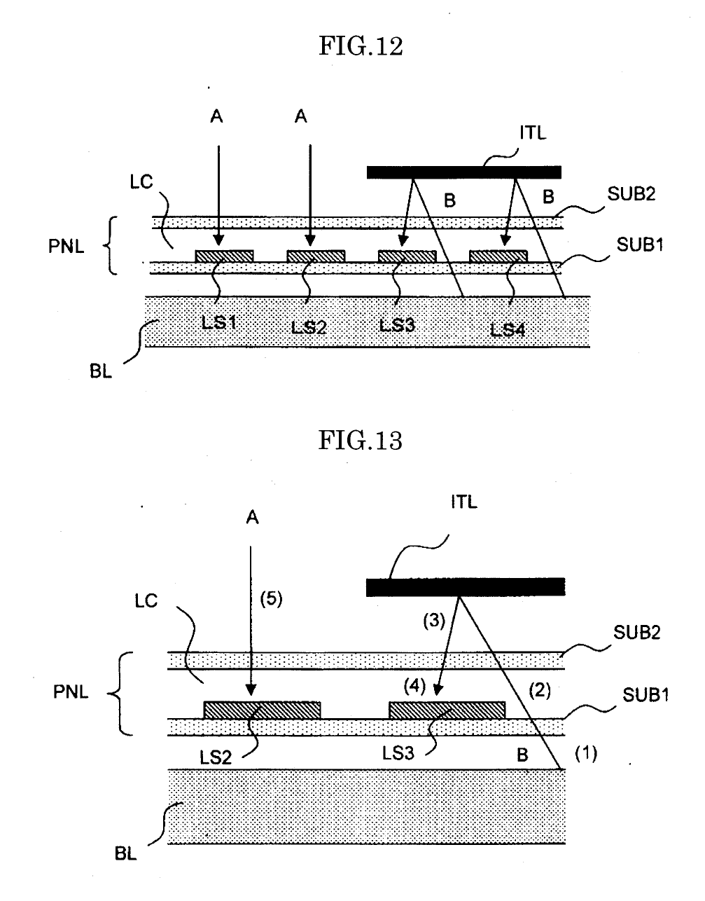

FIG. 8 is a diagram showing the circuit structure of light sensor elements LS where a sensitive and an insensitive state can be switched between, and corresponds to FIG. 3. The structure in FIG. 8 is different from that in FIG. 3 in that a switch SW is formed between the light sensor element LS and the capacitor element C, so that the sensitive state of the light sensor element LS and the insensitive state are switched between when the switch SW is turned on and off. The light sensor circuit in FIG. 8 first stores a charge in the capacitor element C for an initial value, as described above, and the stored charge is released due to leaking of light when the light sensor LS receives light, and as a result, the change in potential at the two ends of the capacitor element C can be sensed. Therefore, the path between the capacitor element C and the light sensor LS is cut by the above described switch SW, so that the structure for nullifying the sensitivity of the light sensor LS is easy to form.

FIG. 9 is a diagram corresponding to FIG. 8, where the above described switch SW in FIG. 8 is formed of a thin film transistor Tr5. The thin film transistor Tr5 is an MIS type transistor, just as the above described thin film transistors Tr1 to Tr4, and can be formed together with the thin film transistors Tr1 to Tr4 during the manufacturing process.

(Backlight)

A substrate that is positioned so as to face the liquid crystal display panel PNL can be used as a backlight BL when a number of light emitting diodes are aligned on the surface on the liquid crystal display panel PNL side. The amount of light from the backlight is extremely easy to control by controlling the current. When the amount of light from the backlight is modulated within a sufficiently short period, it is unnoticeable to the eye. That is to say, it is preferable for the period for modulation of the amount of light from the backlight to be 16 ms or less. In addition, it is preferable for the modulation of the amount of light from the backlight to be control of lighting between +100% and −100%, where turning on and off is repeated. However, the invention is not limited to this.

### Effects Of The Present Embodiment

The effects of the above structure of the present embodiment are described in reference to FIG. 13. As shown in FIG. 13, external light A enters the light sensor element LS2 after passing through the path (5) in the figure. Light from the backlight B enters the light sensor element LS3 after passing through the paths (1) to (4) in the figure.

In the present embodiment, the amount of light from the backlight BL changes between when the light sensor elements LS in even rows receive light and when the light sensor elements LS in odd rows receive light, as described above.

As a result, even in the case where the data on external light A acquired by the light sensor element LS2 for light passing through the path (5) in the figure when the light sensor elements LS in one even row receive light and the data on light from the backlight B acquired by the light sensor element LS3 for light passing through the paths (1) to (4) in the figure are the same, the data on external light A acquired by the light sensor element LS2 for light when the light sensor elements LS in the next even row receive light and the data on light from the backlight B acquired by the light sensor element LS3 for light can be prevented from being the same. Accordingly, in the case of the latter, the light sensor elements LS can detect the light blocking body ITL without fail.

Here, in this structure, the amount of light from the backlight is changed, and therefore, the precision with which the light sensors detect light is ½ in the vertical direction. However, this is within a tolerable range for practical purposes, even in the case where the light sensors are used as elements for a touch panel.

### Second Embodiment

In the above described embodiment, the amount of light from the backlight is modified for each horizontal scan period, and the sensitivity of the light sensor elements changes in the structure. However, the invention is not limited to this, and the same effects can be gained in a structure where the amount of light from the backlight is modified for each period that is an integer multiple of one horizontal scan period, and the sensitivity of the light sensor elements changes.

In particular, in the case where the data of the light sensor elements is read out independently of the drive of pixels for the liquid crystal display, the output can be gained irrespectively of the drive of the pixels for the liquid crystal display. That is to say, the modulation of the amount of light from the backlight and the switching between the sensitivity and the insensitivity of the light sensor elements can be synchronized, so that the modulation of the amount of light from the backlight and the switching between the sensitivity and the insensitivity of the light sensor elements can be carried out for every certain period of time.

### Third Embodiment

In the above described embodiments, the light sensor elements LS are each provided so as to correspond to one pixel in the display region AR of the liquid crystal display panel PNL. However, the invention is not limited to this, and the light sensor elements LS may be arranged in a matrix in part of the display region AR so that only this part functions as a touch panel in the structure. In this case, the part of the display region AR may be at least part of the periphery of the display region AR. In many cases, a number of soft switches are displayed around the periphery of the display region AR, and it is possible to select one such soft switch by touching it with the finger or the like or bringing the finger close to it.

Though embodiments of the present invention are described above, the structures in these embodiments are merely examples, and appropriate modifications are possible for the present invention, as long as the technical idea is not deviated from. In addition, the structures in the respective embodiments may be used in combination, as long as they are compatible with each other.

What is claimed is:

1. A liquid crystal display device, comprising a liquid crystal display panel and a backlight that is positioned so as to face said liquid crystal display panel, characterized in that
said liquid crystal display panel is formed of a number of pixels that are arranged in a matrix in a display region and a number of light sensor circuits that are provided in said display region,
each of said number of light sensor circuits has a light sensor element,
said backlight has a first light intensity and a second light intensity that is different from said first light intensity, and
said first light intensity and said second light intensity are switched between periodically with a predetermined period.

2. The liquid crystal display device according to claim 1, characterized in that
said light sensor circuits have a light receiving period during which the amount of light is detected and a readout period during which the amount of light detected during said light receiving period is read out,
said light receiving period is an integer multiple of said predetermined period,
said light sensor elements have a light sensor operating state with a sensitivity to light and a light sensor non-operating state without sensitivity to light during said light receiving period, and
said light sensor operating state and said light sensor non-operating state are switched between periodically with said predetermined period in sync with the switching of the light intensity of said backlight.

3. The liquid crystal display device according to claim 2, characterized in that said readout period is said predetermined period.

4. The liquid crystal display device according to claim 2, characterized in that
said number of light sensor circuits are arranged in a matrix,
a number of light sensor circuits aligned in the same column from among said number of light sensor circuits take said readout period in sequence, and
the light intensity of said backlight when light sensor elements are in said light sensor operating state is different between light sensor circuits in odd rows and light sensor circuits in even rows from among the number of light sensor circuits aligned in the same column.

5. The liquid crystal display device according to claim 1, characterized in that
said liquid crystal display panel has a number of gate signal lines,
said number of gate signal lines have a scanning signal inputted in sequence for each horizontal scanning period, and
said predetermined period is one horizontal scanning period.

6. The liquid crystal display device according to claim 1, characterized in that
said liquid crystal display panel has a number of gate signal lines,
said number of gate signal lines have a scanning signal inputted in sequence for each horizontal scanning period, and
said predetermined period is an integer multiple of one horizontal scanning period.

7. The liquid crystal display device according to claim 1, characterized in that
said backlight has a light source, and
said first light intensity is a state in which said light source is turned on and said second light intensity is a state in which said light source is turned off.

8. The liquid crystal display device according to claim 1, characterized in that
said light sensor circuits have a light sensor element, a capacitor element and a switch, and
said light sensor element and said capacitor element are connected in series with said switch in between.

9. The liquid crystal display device according to claim 8, characterized in that said switches are formed of a thin film transistor.

10. The liquid crystal display device according to claim 1, characterized in that said light sensor circuits are each formed in one of said number of pixels.

11. The liquid crystal display device according to claim 1, characterized in that said light sensor circuits are provided in part of said display region.
